(19) United States
(12) Patent Application Publication
(10) Pub. No.: US 2013/0320057 A1
(43) Pub. Date: Dec. 5, 2013

(54) Motorcycle Cargo Rack

(71) Applicant: Cameron James, Matthews, NC (US)

(72) Inventor: Cameron James, Matthews, NC (US)

(21) Appl. No.: 13/486,800

(22) Filed: Jun. 1, 2012

(51) Int. Cl. B62J 11/00

(52) U.S. Cl. CPC B62J 11/00
USPC 224/413

(57) ABSTRACT

A cargo adaptor for a motorcycle includes a support arm configured to attach to at least one standardized frame component of the motorcycle, a crossbeam extending from the support arm, and a rack mounting point disposed on the crossbeam. The rack mounting point is configured to support a rack along a longitudinal centerline of the motorcycle above the rear suspension thereof while the motorcycle is operated under normal driving conditions. A cargo system for a motorcycle including the cargo adaptor further includes a cargo rack attached to the mounting point, wherein the orientation of the cargo rack evenly distributes the weight of the system and any cargo contained therein such that the motorcycle may be operated in a normal manner. A method for removably attaching the cargo system to existing frame elements of the motorcycle is also described herein.

### BACKGROUND

A motorcycle cargo rack configured to carry elongated cargo such as a golf bag and clubs was described by this Applicant in U.S. Pat. No. 6,938,806. While this previous design of a motorcycle cargo rack was suitable for it intended purpose, this application presents improvements thereon.

Travel by motorcycle presents unique issues and challenges related to balance and stability. Motorcycle riders typically require special licensing as a direct result of these challenges. Because motorcycles are not typically designed to carry loads (other than the rider), such as a cargo rack and associated cargo, special care must be taken to ensure that balance and stability of the bike is maintained. Moreover, unbalanced loads can lead to stability issues, especially at slow speeds. Elongated loads, such as a golf bag and clubs, can further aggravate the issues of balance. Further, it is advantageous to provide a ready means for attaching and detaching the cargo and/or cargo rack from the motorcycle. Accordingly, a cargo rack designed to balance an associated load and thereby maximize stability and safety, while also providing for ready attachment and removal, is presented herein.

### SUMMARY

A cargo adaptor for a motorcycle includes a support arm configured to attach to at least one standardized frame component of the motorcycle, a crossbeam extending from the support arm, and a rack mounting point disposed on the crossbeam. The rack mounting point is configured to support a rack along a longitudinal centerline of the motorcycle above the rear suspension thereof while the motorcycle is operated under normal driving conditions. A cargo system for a motorcycle including the cargo adaptor further includes a cargo rack attached to the mounting point, wherein the rack mounting point supports the cargo rack in a lateral orientation with respect to the longitudinal plane of the motorcycle such that the longitudinal axis of the cargo rack is offset by an angle from the longitudinal plane of the motorcycle, and wherein the orientation of the cargo rack evenly distributes the weight of the system and any cargo contained therein such that the motorcycle may be operated in a normal manner. A method for removably attaching the cargo system to existing frame elements of the motorcycle is also described herein.

### BRIEF DESCRIPTION OF THE DRAWINGS

The features and advantages of the various exemplary approaches of this disclosure, and the manner of attaining them, will become more apparent and better understood by reference to the accompanying drawings, wherein:

FIG. 1 is a side view of an exemplary cargo system according to the invention installed on a motorcycle.

FIG. 2 is an end view of the cargo system installed on a motorcycle.

FIG. 3 is a perspective view of an exemplary frame adaptor.

FIG. 4 is a perspective view of an exemplary cargo rack.

FIG. 5 is a side view of an, alternative embodiment of the cargo system according to the invention.

FIG. 6 is a perspective view of the frame adaptor of the embodiment of FIG. 5.

### DETAILED DESCRIPTION

It is to be understood that the following disclosure and claims are not limited in application to the details of construction and the arrangement of components set forth in the following description or illustrations. The disclosure is capable of other exemplary approaches and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Furthermore, and as described in subsequent paragraphs, the specific mechanical configurations illustrated in the drawings merely provide exemplary approaches and other alternative mechanical configurations are possible.

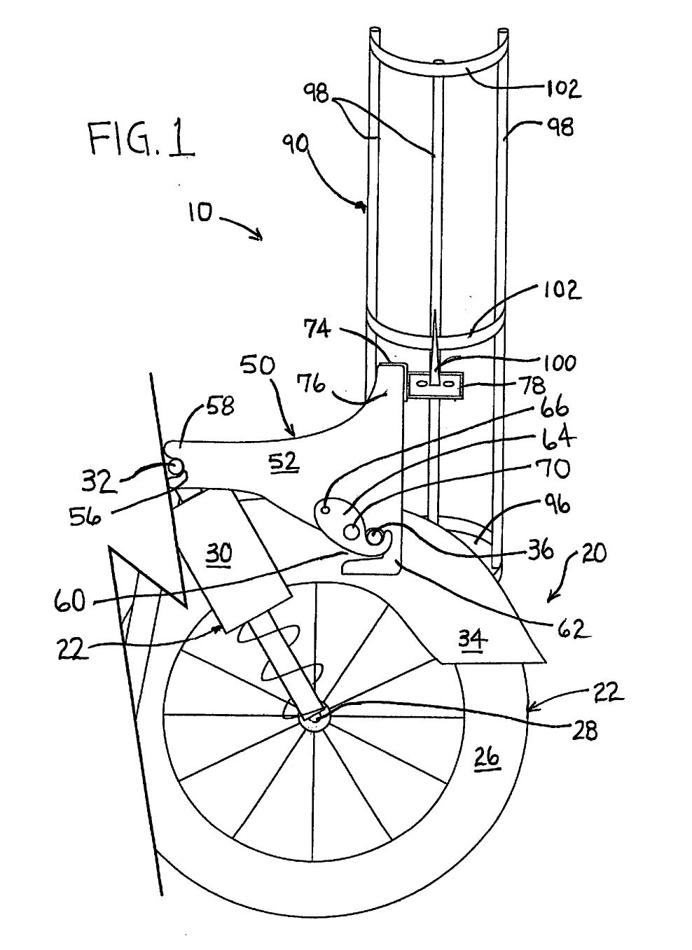

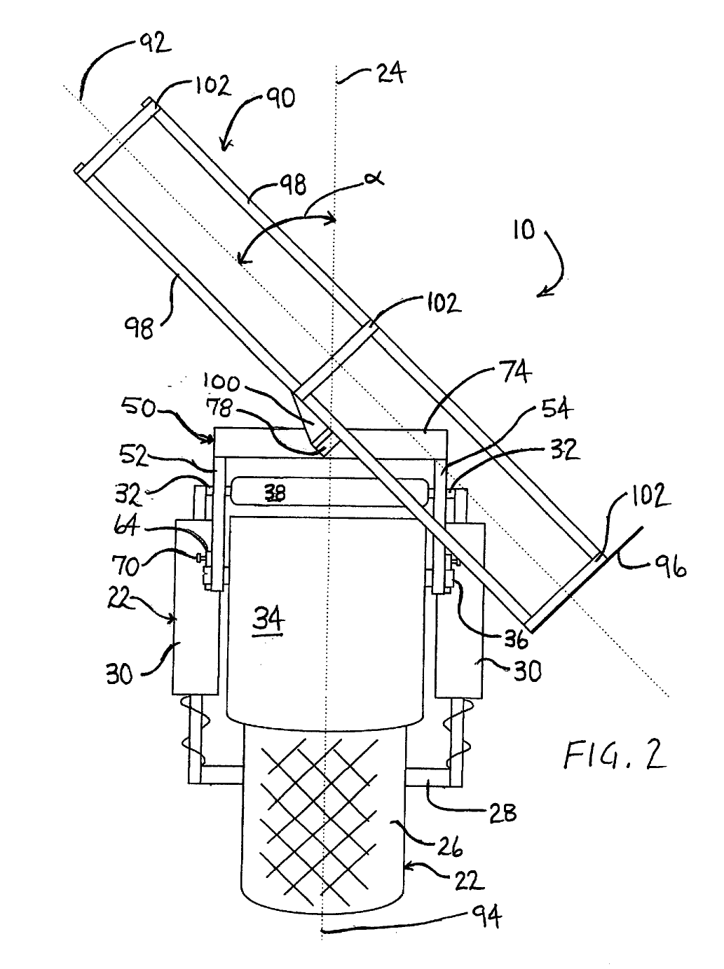

Referring now to FIGS. 1 and 2, an exemplary cargo carrying system 10 installed on a motorcycle 20 includes a frame adaptor 50 and a cargo rack 80. The cargo system 10 including the elongated cargo rack 80 is ideally suited for carrying elongated items, such as a golf bag and clubs, via a motorcycle 20 without negatively impacting the balance and stability thereof. In particular, the cargo system 10 installs over rear suspension elements 22 motorcycle 20 and aligns the weight of the cargo rack with the longitudinal axis 24 of the motorcycle. Accordingly, cargo loaded into the cargo system 20 is effectively balanced both laterally and longitudinally over the rear suspension elements 22 of the motorcycle 20. The motorcycle 20 includes a rear wheel 26, an axle supporting the rear wheel 28, and struts 30. The struts 30 generally interconnect the axle 28 and the motorcycle frame. The wheel 26, axle 28, and struts 30 are all rear suspension elements 22 suitable for carrying a load thereabove, such as a load positioned within the cargo system 10.

As mentioned above, motorcycles 20 are not specifically designed to carry cargo. Accordingly, attaching cargo to the motorcycle 20 introduces challenges related to securing the cargo to the motorcycle. In one exemplary approach, existing frame components may be used to secure a cargo load to the bike. For example, the motorcycle typically includes a fender 34 which is not designed to carry loads. In general, a cargo load will ideally be secured to the frame, or components thereof, of the motorcycle 20. Motorcycle manufactures typically expose portions of the motorcycle frame. Exposed portions of the frame may simply be inadvertent or aesthetic, or alternatively may serve as a functional design aspect. In the alternative, a forward fender attachment point 32 and a rearward fender mount point 36 can be provided. The motorcycle 20 may also include a so-called sissy bar 38 or rear seat (not shown) that attaches to the forward fender attachment point 32. However, other motorcycle designs may include a separate attachment point for the sissy bar 38 disposed on the frame that is separate from the forward fender attachment point 32.

The forward fender attachment point 32, the rearward fender mount point 36, and an alternate sissy bar attachment point (not separately shown), all represent existing motorcycle components that are exposed and available for attaching additional components thereto. By relying on existing frame components, motorcycle owners may adapt their bikes for specific uses without materially resorting to material alterations that could damage the bike. Moreover, the motorcycle 20 may be selectively configured for a specific purpose, such as carrying a load, and later be returned to is original configuration. As will be discussed in more detail below, the cargo system 10 disclosed herein is configured to be removably attachable to the motorcycle 20. For example, the cargo system 10 may include a frame adaptor 50 that is configured to selectively attach to existing frame components, or to the forward fender attachment point 32, rearward fender mount point 36 or separate sissy bar attachment point (not shown).

Motorcycle manufactures often standardize aspects of the designs of their product lines. Moreover, certain design elements are disposed in a standardized position or shape on different models of motorcycles. This design standardization not only provides design and manufacturing advantages, but also allows for add-on components to interconnect with a range of motorcycle models. For example, the existing components such as the forward fender attachment point 32 and the rearward fender mount point 36 may be disposed on the frame according to a standardized arrangement with respect to other elements of the motorcycle such as the frame, the rear axle, etc. Across a product line, the forward fender attachment point 32 and the rearward fender mount point 36 may be disposed at a standardized distance and angle from each other and with respect to rear suspension elements 22. Accordingly, the cargo system 10 is configured to take advantage of this design standardization by providing an frame adaptor 50 that interconnects with existing frame components that are disposed according to a standardized design. Thus, such a frame adaptor 50 may interconnect with a wide variety of motorcycle designs.

In general, the frame adaptor 50 provides a rigid support structure on which the cargo rack 80 may be mounted. Moreover, the frame adaptor 50 compensates for the fact that the motorcycle 20 typically lacks a suitable mounting point for the cargo rack 80. For example, the cargo rack 80 is ideally disposed over the rear suspension elements 22 and aligned with a longitudinal plane 24 of the motorcycle 20. The fender 34 typically resides in this position, but, as discussed above, is ill suited for carrying the load of the cargo rack 80. Moreover, it is preferable to mount the cargo rack some distance above the height of the fender 34. Accordingly, the frame adaptor 50 provides a mounting point 52 that is disposed over the rear suspension elements 22 and aligned with a longitudinal plane 24 of the motorcycle 20.

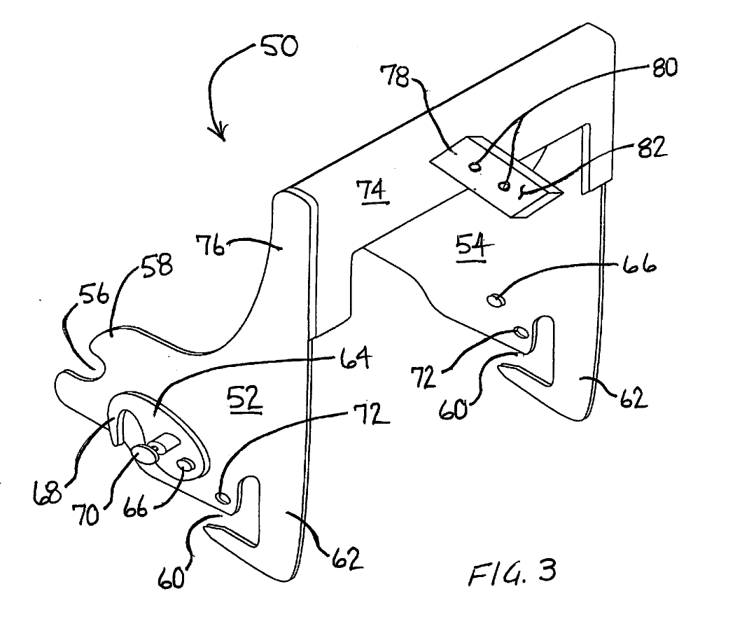

As explained above, the frame adaptor 50 is configured to attach to existing frame elements, e.g., the forward fender attachment point 32 and the rearward fender mount point 36. The frame adaptor 50 (FIG. 3) includes first and second support arms 52, 54 which attach to opposing sides of the motorcycle 20. While the depicted exemplary approach includes two support arms 52, 54, other exemplary approaches may include only a single support arm. The support arms 52, 54 are symmetric and will be as a single element below. The support arm 52 may be composed of any rigid and strong material such as steel or aluminum, and may be machined from a single sheet or plate or formed from a plurality of sub-portions (not shown) that are welded together. The support arm 52 is a substantially planar or flange-like component, which is removably attached to the motorcycle 20 in a vertical orientation parallel to the longitudinal axis 24 of the motorcycle.

In order to attach to the existing frame elements of the motorcycle 20, the support arm 52 includes multiple mounting sockets or channels. A pivot socket 56 is disposed on a front end 58 of the support arm 52. The pivot socket 56 is substantially U-shaped and opens toward the front end 58 of the support arm 52. The pivot socket 56 is sized and positioned to receive the forward fender attachment point 32. A second rear channel 60 is disposed on a lower rear end 62 of the support arm. The rear channel 60 is substantially L-shaped and configured to receive the rearward fender mount point 36. To secure the support arm 52 to the existing frame elements, the rear channel 60 is paired with a locking clamp 64. The locking clamp 64 is attached to the side of the support arm via a pin 66 and can freely rotate about the pin in a plane parallel to the plane of the support arm 52. The locking clamp 64 includes a clamp arm 68 and a spring-biased bolt 70 (spring not shown). The bolt 70 is biased to the closed or locked position such that it can easily engage a locking hole 72 provided on the support arm 52. When installed, the clamp arm braces and locks the fender mount point 36 into the rear channel 60. The spring-biased bolt 70 acts as a quick release mechanism that allows for the rapid installation and removal of the frame adaptor 50.

The frame adaptor 50 further includes a crossbeam 74 extending between an upper end 76 of the two support arms 52, 54. Accordingly, the frame adaptor 50 provides flange-like support arms 52, 54 that are symmetric and arranged parallel to each other, which are interconnected by the crossbeam 74. Moreover, the support arms 52, 54 are slightly triangular with the pivot socket 56, rear channel 60 and crossbeam 74 being disposed at respective vertices. As depicted, the crossbeam 74 may wrap around two sides of the support arms 52, 54 to maximize the structural support provided thereto.

A rack mounting point 78 is disposed on the crossbeam 74 centrally between the the support arms 52, 54. The rack mounting point 78 is configured to support a rack 90 along a longitudinal centerline of the motorcycle above the rear suspension thereof while the motorcycle is operated under normal driving conditions. As depicted, the mounting point 78 may be a distinct element from the crossbeam 74 and protrude outwardly therefrom. However, in other exemplary approaches, the mounting point may be provided integrally with the crossbeam 74. The mounting point 78 includes holes 80 for attaching the rack 90 thereto. Bolts or screws (not shown) secured by wing nuts, or the like, may attach the rack 90 to the mounting point 78 in a selectively removable arrangement. Moreover, bolts and wing nuts may act as a quick release mechanism to allow for the rapid installation and removal of the rack 90 to the mounting point 78.

As depicted, the mounting point 78 includes an angled mounting surface 82. The angled mounting surface 82 is configured to support the rack 90 in a lateral orientation with respect to the longitudinal plane 24 of the motorcycle such that a longitudinal axis 92 of the cargo rack 90 is offset by an angle a from the longitudinal plane 24 of the motorcycle. While the angled surface 82 effectively causes the rack 90 to be held at an angle, other exemplary approaches could include a mounting point 78 with a mounting surface parallel to the upper edge of the crossbeam 74. In this alternative approach, in order to keep the rack 90 mounted over the centerline of the motorcycle, a bracket or the like attached to the rack 90 provides the angled orientation.

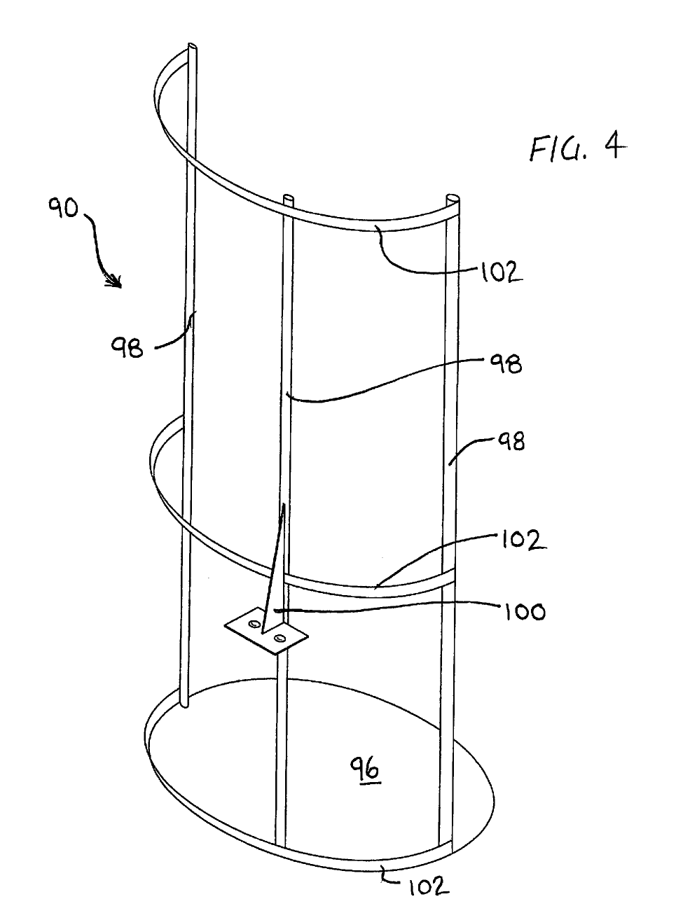

As discussed above, the cargo system 10 is configured to support an elongated cargo rack 90 (FIG. 4). The cargo rack 90 is ideally suited to carry elongated cargo. For example, golf clubs, musical instruments, firearms, etc., all could be carried within the cargo rack 90. The rack has a longitudinal axis 92, which is offset from the vertical when installed on the mounting point 78. The particular angle of offset a can correspond to the center of gravity 94 of the rack 90 and any load thereof. Accordingly, the angle of offset adjusts the center of gravity 94 such that it is aligned over the mounting point 78 when installed thereon. While implementations of the cargo rack 90 can vary to meet the needs of the cargo being carried, as depicted, the rack includes a base 96, a plurality of longitudinally extending support beams 98, one or more support braces 102 that laterally interconnect the support beams, and a bracket 100 attached to one of the beams configured to be removably attachable to the mounting point 78. The rack 90 may further include one or more cargo straps (not shown) to secure the cargo within the rack. As discussed above, the bracket 100 may have a surface that is disposed parallel to the base 96 such that when attached to the angled surface 82 of the mounting point 78, the rack is held at an angle offset from the vertical. However, in another exemplary approach, the surface of the bracket 100 may be angled to enforce the angled orientation of the rack when installed.

As explained above, the cargo system 10 is configured to be selectively installed and removed as necessary. To install the system 10, the frame adaptor 50 is positioned above the rear suspension elements 22 and aligned with the existing frame components. The forward fender attachment point 32 is inserted into the pivot socket 56. The frame adaptor 50 is then pivoted downwardly until the rear channel 60 engages with the rearward fender mount point 36. The clamp arm 68 of the locking clamp 64 is then rotated until the spring biased bolt 70 aligns with the hole 72, and under the bias of the spring, engages the hole 72. Next, the rack 90 is aligned over the frame adaptor 50 such that the bracket 100 abuts the mounting point 78. The rack 90 and frame adaptor 50 are then bolted together and secured with wing nuts or the like.

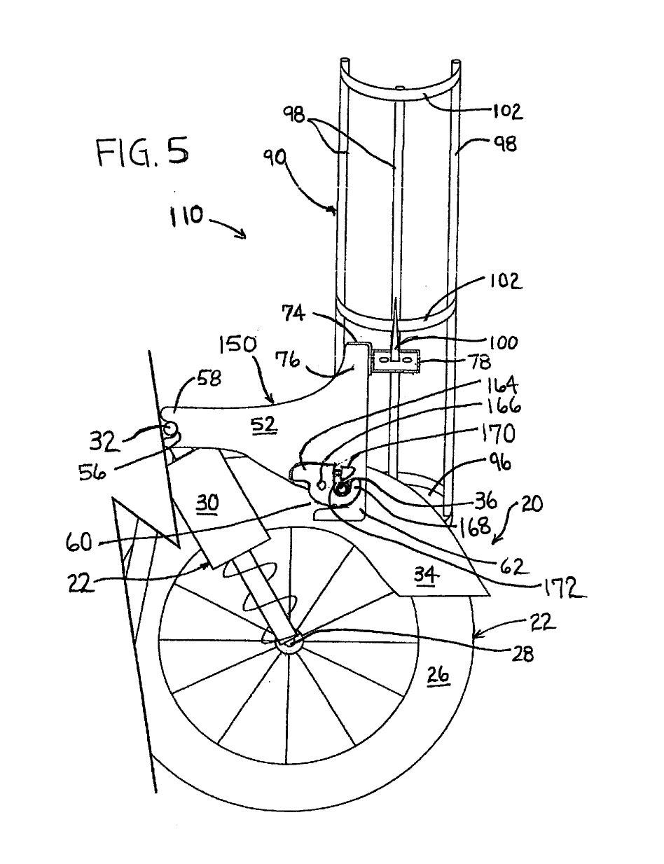

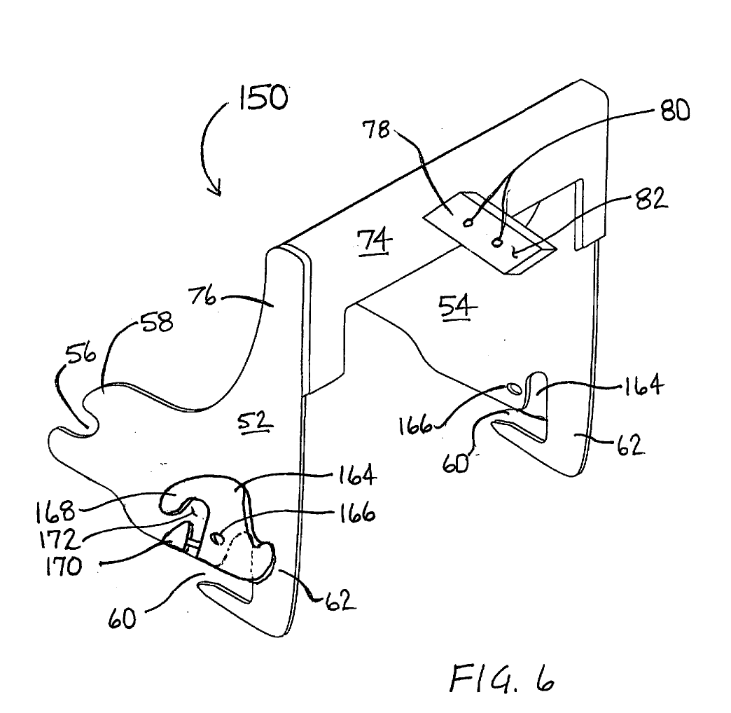

In an alternative embodiment illustrated in. FIGS. 5-6, cargo system 110 utilizes a frame adaptor 150 that is constructed similar to the frame adaptor 50 of FIG. 3. A locking clamp 164 is pivotally attached to the frame adaptor 150 by a pin 166. The locking clamp has a clamp arm 168 and a spring-biased retainer 170 that define a socket 172 therebetween. To install the system 110, the frame adaptor 150 is aligned with existing frame components of the motorcycle in the same manner as with the previous embodiment. As the rearward fender mount point 36 enters the rear channel 60, however, the locking clamp 164 is rotated so that the rearward fender mount point 36 pushes against the spring-bias of the retainer 170. As the rearward fender mount point 36 fully engages the socket 172, the retainer 170 extends under the spring-bias and traps the rearward fender mount point 36 in the socket 172 (FIG. 5). The frame adaptor 150 is removed by depressing the retainer 170 against the spring-bias and rotating the clamp 164 away from the rearward fender mount point 36. The frame adaptor 150 can then be lifted away from from the points 32, 36.

The foregoing description of methods and exemplary approaches has been presented for purposes of illustration. It is not intended to be exhaustive or to limit the below-listed claims to the precise steps and/or forms disclosed, and obviously many modifications and variations are possible in light of the above teaching. It is intended that the scope of the disclosure be defined by the claims appended hereto.

1. A cargo carrying frame adaptor for a. motorcycle, comprising:
a support arm configured to attach to at least one standardized frame component of the motorcycle utilizing a locking clamp having a spring-biased locking member;
a crossbeam extending from, the support arm; and
a rack mounting point disposed on the crossbeam, wherein the rack mounting point is configured to support a rack along a longitudinal centerline of the motorcycle above the rear suspension thereof while the motorcycle is operated under normal driving conditions.

2. The cargo carrying frame adaptor according to claim 1, further comprising an angled mounting surface disposed on the rack mounting point configured to support the rack in a lateral orientation with respect to the longitudinal plane of the motorcycle such that the longitudinal axis of the cargo rack is offset by an angle from the longitudinal plane of the motorcycle.

3. The cargo carrying frame adaptor according to claim 1, wherein the frame adaptor is removably attachable to the motorcycle.

4. The cargo carrying frame adaptor according to claim 1, further comprising a pivot socket disposed on a first end of the support arm, said locking clamp disposed on a second end of the support arm, wherein the pivot socket is configured to engage a first standardized frame component of the at least one standardized frame component and the locking clamp is configured to engage a second standardized frame component of the at least one standardized frame component.

5. The cargo carrying frame adaptor according to claim 4, wherein the first and second standardized frame components include at least one of a sissy bar mount point and a fender mount point.

6. The cargo carrying frame adaptor according to claim 4, wherein the locking clamp includes a clamp arm and said spring-biased locking member provides a quick-release mechanism to selectively lock the clamp arm against the second standardized frame component.

7. The cargo carrying frame adaptor according to claim 1, further comprising a second support arm attached to the side of the motorcycle opposite the support arm supporting a second end of the crossbeam, wherein the support arm and the second support arm are symmetric.

8. A cargo system for a motorcycle having a rear suspension, comprising:
a frame adaptor configured to removably attach to the motorcycle via a quick release mechanism such that he cargo system may be selectively installed on and removed from the motorcycle, the quick release mechanism including a clamp arm and a spring-biased locking member;
a rack mounting point disposed on the adaptor along a longitudinal plane of the motorcycle above the rear suspension thereof; and
a cargo rack attached to the mounting point, wherein the rack mounting point supports the cargo rack in a lateral orientation with respect to the longitudinal plane of the motorcycle such that the longitudinal axis of the cargo rack is offset by an angle from the longitudinal plane of the motorcycle, and wherein the orientation of the cargo rack evenly distributes the weight of the system and any cargo contained therein such that the motorcycle may be operated in a normal manner.

9. The cargo system according to claim 8, wherein the frame adaptor is configured to attach to standardized frame components of the motorcycle.

10. The cargo system according to claim 8, wherein the cargo rack is removably attached to the rack mounting point via a second quick release mechanism such that the cargo rack may be selectively installed on and removed from the frame adaptor.

11. The cargo system according to claim 8, wherein the center of gravity of the cargo rack and cargo held therein is disposed over the rear suspension of the motorcycle and aligned with the longitudinal plane of the motorcycle.

12. The cargo system according to claim 8, wherein the cargo rack is configured to carry a golf bag and clubs and includes a base, a plurality of elongated support beams extending from the base, and at least one brace interconnecting to the support beams, and wherein the cargo rack attaches to the mounting point via at least one of the support beams and the brace.

13. A cargo carrying frame adaptor for a motorcycle having at least one standardized frame component, comprising:
a first support flange;
a second support flange spaced apart from the first support flange and aligned in a parallel orientation thereto;
a locking clamp disposed on each support flange, the locking clamp including a spring-biased locking member configured to retain the frame adaptor on the motorcycle;
a crossbeam interconnecting the first and second support flanges; and
a cargo rack mounting point disposed on the crossbeam centrally between the first and second support flange, wherein the the mounting point is configured to support a cargo rack in a lateral orientation with respect to the longitudinal plane of the motorcycle such that the longitudinal axis of the cargo rack is offset by an angle from the longitudinal plane of the motorcycle, and wherein the orientation of the cargo rack evenly distributes the weight of the system and any cargo contained therein such that the motorcycle may be operated in a normal manner.

14. The cargo carrying frame adaptor according to claim 13, wherein the first and second support flanges are symmetric equivalents.

15. The cargo carrying frame adaptor according to claim 13, further comprising an angled mounting surface disposed on the mounting point.

16. The cargo carrying frame adaptor according to claim 13, wherein the frame adaptor is removably attachable to the motorcycle.

17. The cargo carrying frame adaptor according to claim 13, further comprising a pivot socket disposed on a first end of each support flange and configured to engage first standardized frame components of the at least one standardized frame component, and said locking clamp is disposed on a second end of each support flange and configured to engage second standardized frame components of the at least one standardized frame component.

18. The cargo carrying frame adaptor according to claim 17, wherein the first and second standardized frame components include at least one of a sissy bar mount point and a fender mount point.

19. The cargo carrying frame adaptor according to claim 17, wherein the locking clamps each further include a clamp arm and said spring-biased locking member provides a quick-release mechanism to selectively lock the clamp arm against the respective second standardized frame component.
